(19) United States
(12) Patent Application Publication
(10) Pub. No.: US 2006/0265387 A1
(43) Pub. Date: Nov. 23, 2006

(54) Method and apparatus for loading artifacts

(75) Inventors: Mandar Ganesh Bhatkhande, Sunnyvale, CA (US); Christopher Shane Claussen, Austin, TX (US); Paul Fredric Griepentrog, San Francisco, CA (US); Xiaochun Mei, Palo Alto, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/133,709

(22) Filed: May 20, 2005

(51) Int. Cl. G06F 17/30

(52) U.S. Cl. 707/10

(57) ABSTRACT

A method, apparatus, and computer usable code for locating artifacts. A query is received from a client to locate an artifact, wherein the request includes a set of criteria for the artifact. A request is sent to a set of locators based on the set of criteria in the request in response to receiving the request, and a reply is returned to the client, wherein the reply includes a pointer to the artifact in response to receiving a positive response from the set of locators.

### BACKGROUND OF THE INVENTION

1. Field of the Invention

The present invention relates generally to an improved data processing system and in particular to a method and apparatus for processing data. Still more particularly, the present invention relates to a method, apparatus, and computer usable code for loading artifacts.

2. Description of the Related Art

A common problem occurs in searching for resources in a given environment when a program or application is required to search for the items based on a certain set of criteria. A user is often required to input a location of data that is required to run the program or application. For example, an application may require a particular class or may require an entry from a database. Currently, a user is required to enter a path to that particular piece of data to facilitate the continued running of the application. Such requirement is time consuming because the user often does not know the location of the particular piece of data that is needed.

Attempts to solve this problem have been made in Java. One attempt includes using location-dependent metadata. Existing systems often require configuration and metadata that drives their processes to exist in a particular location within the confines of the application or run-time environment. In another solution, static metadata is used. Existing systems often treat configuration and algorithmic metadata in a very static manner. For example, metadata often is compiled into runtime objects that are class loaded (and thus cached). JAX-RPC runtimes is a good example of this phenomenon. On the other hand, Java server pages are a good example of a runtime that is compiled down into Java, providing a high performant runtime, but continues to provide dynamicity by recompiling the metadata into Java byte codes dynamically during runtime execution.

In Java, class names have been used to locate and load classes using a class loader within a Java virtual machine. Additionally, resources also have been located based on a path. In Java, a class loader is used to achieve this goal using a given class path. These solutions, however, do not address the loading of artifacts based on other criterion, such as name space or type. One drawback to this approach in Java is that the user program has to search the entire class path to find a particular artifact. This process involves a large amount of coding, testing, and implementation effort for the programmers. Also, these types of approaches may yield solutions that are non-generic. In other words, these solutions are typically limited to artifact-loading to certain types based on certain queries. As a result, these solutions become useless for new types that may be added from time to time. Additionally, these solutions also cannot be directly plugged in or implemented under third-party infrastructures.

Thus, it would be advantageous to have an improved method, apparatus, and computer usable code to generically load artifacts.

### SUMMARY OF THE INVENTION

The present invention provides a method, apparatus, and computer usable code for locating artifacts. A query is received from a client to locate an artifact, wherein the query includes a set of criteria for the artifact. A request is sent to a set of locators based on the set of criteria in the query in response to receiving the request, and a reply is returned to the client in response to receiving a positive response from the set of locators. The reply includes a pointer to the artifact.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system that may be implemented as a server in accordance with an illustrative embodiment of the present invention;

FIG. 3 is a block diagram of a data processing system shown in which aspects of the present invention may be implemented;

FIG. 4 is a diagram illustrating a generic artifact loading system in accordance with an illustrative embodiment of the present invention;

FIG. 5 is a diagram illustrating an artifact loader framework in accordance with an illustrative embodiment of the present invention;

FIGS. 6A-6C are diagrams illustrating an artifact loader framework in accordance with an illustrative embodiment of the present invention;

FIGS. 7A-7D are diagrams illustrating example implementations using a generic artifact loader framework in accordance with different aspects of the present invention;

FIG. 8 is a flowchart of a process for processing a query in an artifact loader in accordance with a preferred embodiment of the present invention;

FIG. 9 is a flowchart of a process for sending a query to an artifact loader in accordance with a preferred embodiment of the present invention;

FIGS. 10A-10B are example usable code for an artifact loader in accordance with an illustrative embodiment of the present invention; and

FIG. 11 is a diagram illustrating example code snippets used to call an artifact loader in accordance with an illustrative embodiment of the present invention.

### DETAILED DESCRIPTION OF THE PREFERRED EMBODIMENT

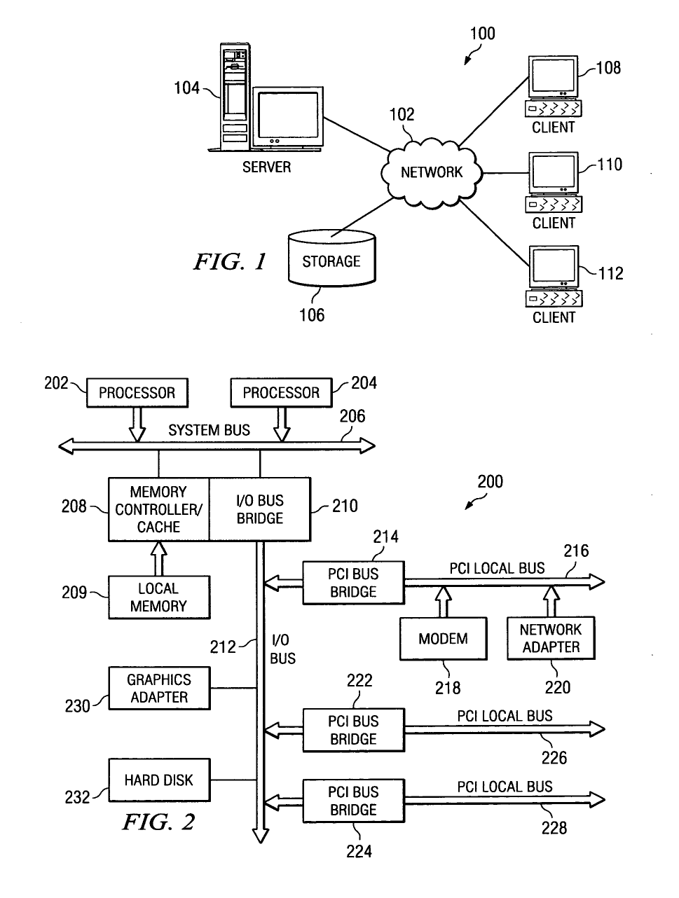

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 connects to network 102 along with storage unit 106. In addition, clients 108, 110, and 112 connect to network 102. These clients 108, 110, and 112 may be, for example, personal computers or network computers. In the depicted example, server 104 provides data, such as boot files, operating system images, and applications to clients 108, 110, and 112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 that connect to system bus 206. Alternatively, a single processor system may be employed. Also connected to system bus 206 is memory controller/cache 208, which provides an interface to local memory 209. I/O bus bridge 210 connects to system bus 206 and provides an interface to I/O bus 212. Memory controller/cache 208 and I/O bus bridge 210 may be integrated as depicted.

Peripheral component interconnect (PCI) bus bridge 214 connects to I/O bus 212 provides an interface to PCI local bus 216. A number of modems may be connected to PCI local bus 216. Typical PCI bus implementations will support four PCI expansion slots or add-in connectors. Communications links to clients 108, 110, and 112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both).

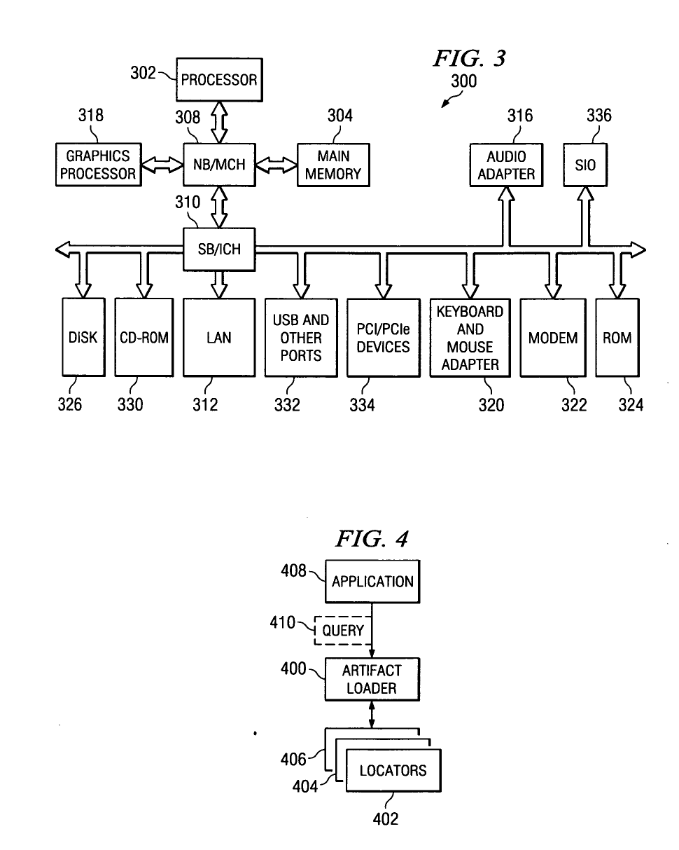

With reference now to FIG. 3, a block diagram of a data processing system is shown in which aspects of the present invention may be implemented. Data processing system 300 is an example of a computer, such as client 108 in FIG. 1, in which code or instructions implementing the processes for embodiments of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM drive 330, universal serial bus (USB) ports and other communications ports 332, and PCI/PCIe devices 334 connect to ICH 310. PCI/PCIe devices may include, for example, Ethernet adapters, add-in cards, PC cards for notebook computers, etc. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and coordinates and provides control of various components within data processing system 300 in FIG. 3. The operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 300 (Java is a trademark of Sun Microsystems, Inc. in the United States, other countries, or both).

Instructions for the operating system, the object-oriented programming system, and applications or programs are located on storage devices, such as hard disk drive 326, and may be loaded into main memory 304 for execution by processor 302. The processes for embodiments of the present invention are performed by processor 302 using computer implemented instructions, which may be located in a memory such as, for example, main memory 304, memory 324, or in one or more peripheral devices 326 and 330. These processes may be executed by any processing unit, which may contain one or more processors.

Those of ordinary skill in the art will appreciate that the hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the present invention may be applied to a multiprocessor data processing system.

As some illustrative examples, data processing system 300 may be a personal digital assistant (PDA), which is configured with flash memory to provide non-volatile memory for storing operating system files and/or user-generated data.

A bus system may be comprised of one or more buses, such as system bus 206, I/O bus 212 and PCI buses 216, 226 and 228 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2 or modem 322 or LAN 312 of FIG. 3. A memory may be, for example, local memory 209 or cache such as found in memory controller/cache 208 of FIG. 2 or main memory 304 of FIG. 3. A processing unit may include one or more processors or CPUs, such as processor 202 or processor 204 of FIG. 2 or processor 302 of FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

The present invention provides a method, apparatus, and computer usable code for generically loading artifacts. In response to a request for an artifact, an artifact loader generates requests to locators associated with the artifact loader in an attempt to locate the artifact using the parameters in the request.

In these examples, an artifact is data needed by the application requesting the data to run or execute a process. This data may be, for example, an entry from a database, a text file, an XML file, a table, a class, a dynamic link library file, a value, or some other object.

When results are received from the locators, these results are returned to the requesting client application. In this manner, loose coupling of the metadata that drives the components from the components themselves is enabled through providing this location transparent metadata access.

With reference next to FIG. 4, a diagram illustrating a generic artifact loading system is depicted in accordance with an illustrative embodiment of the present invention. In this example, artifact loader 400 is used in conjunction with locators 402, 404, and 406 to locate and load artifacts for use by different applications requesting the artifacts. In this example, artifact loader 400 receives query 410 for an artifact from application 408. This request may be received directly by artifact loader 400 or through an intermediate process or component depending on the particular implementation. Artifact loader 400 typically reads artifact data residing in a storage environment and is usually associated with a component that helps it to read the artifact content. In this example, these components are locators 402, 404, and 406.

Artifact loader 400 is a primary component in this artifact loading system or framework. Artifact loader 400 serves as an engine or orchestration vehicle to drive queries over a framework. With this mechanism, a user is not required to locate or enter location information for an artifact. In these examples, the queries are sent to locators 402, 404, and 406. These locators are used to search one or more different storage mediums in which artifacts may be located. Locators 402, 404, and 406 are search processes that are specific to an environment. For example, locators 402, 404, and 406 may include search processes located in a file system or may be a relational database. As mentioned before, in these illustrative examples, an artifact is data needed by an application to execute or run a process.

Artifact loader 400 may be designed to contain a single component or a number of different subcomponents or subsystems depending on the implementation. When artifact loader 400 manages a given scope and the set of location providers in that scope receives a query for a particular artifact type, artifact loader 400 is responsible for distributing that query to the different locators, such as locators 402, 404, and 406.

In this example, artifact loader 400 contains a generic interface to communicate with locators 402, 404, and 406. Artifact loader 400 performs the necessary translations or conversions of requests received from application 408 to generate appropriate requests that are recognizable by locators 402, 404, and 406. These translations or conversions may include, for example, reformatting of parameters received in the request and placing the data into appropriate fields that will be recognized by the locator to which a query is to be sent. In these examples, a query and a request are interchangeable but are used to distinguish between what is received by an artifact loader and a locator for purposes of more clearly illustrating the mechanisms of the present invention.

In response to receiving a request from artifact loader 400, locators 402, 404, and 406 scan the environment for the supported artifact types and for all criteria and create pointers that point to the artifacts corresponding to the criteria. In these examples, these pointers take the form of universal resource locators (URLs), which are returned to artifact loader 400. These pointers could take other forms, such as, for example, a memory address or a path, depending on the particular environment and implementation.

Example criteria found in a query include name space and type. Name spaces essentially define the scope of a name or symbol—that portion of a program or collection of classes in which the name or symbol has meaning. Distinct name spaces protect variable and method names from conflicts, which are also called name collusions. A type is data describing the types of data that may be present. A type may be, for example, extensible markup language (XML) schema complex type, XML schema simple type, and XML element type. A type also may be, for example, a file extension or MIME type. Although these examples illustrate three locators, any number of locators may be associated with artifact loader 400. A set of locators associated with artifact loader 400 may include one or more locators.

In these examples, artifact loader 400 may support any number of types of artifacts. The implementation of artifact loader 400 may dictate how an artifact type should be implemented and will actually depend on the environment in which artifact loader 400 operates.

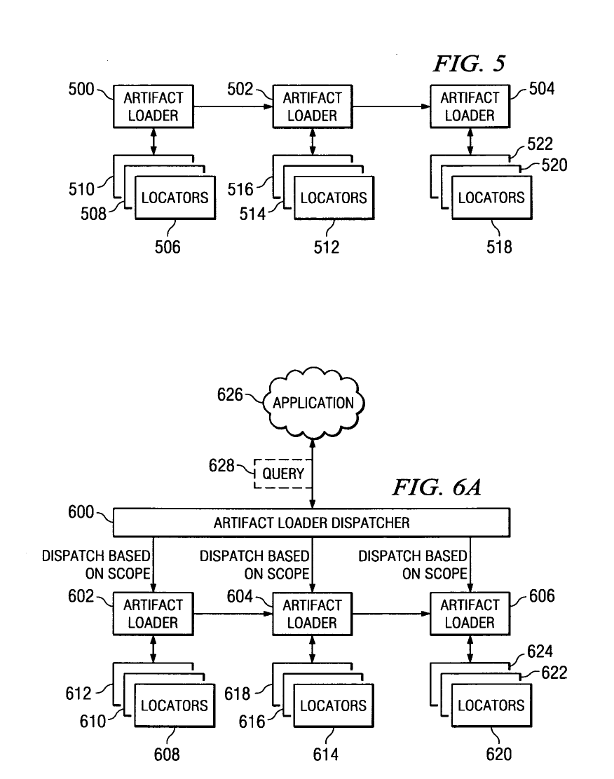

Each artifact loader is associated with a scope. A scope is the environment or universe that is handled by a particular artifact loader. Turning next to FIG. 5, a diagram illustrating an artifact loader framework is depicted in accordance with an illustrative embodiment of the present invention. In this example, the framework contains artifact loader 500, 502, and 504. Each of these artifact loaders are associated with a set of locators. In this illustrative example, artifact loader 500 is associated with locators 506, 508, and 510; artifact loader 502 is associated with locators 512, 514, and 516; and artifact loader 504 is associated with locators 518, 520, and 522.

The framework illustrated in FIG. 5 works much like a class loader in which multiple scopes are enabled. Artifact loaders 500, 502, and 504 may be chained together in which a policy governs the scope of each particular artifact loader in the chain. The scope in these examples is determined by locators plugged in to each artifact loader. In the illustrative examples, one artifact loader is present for each scope. The policy governing the scope for each loader in this chain is determined by the locators associated or plugged in to each artifact loader. In this illustrative example, one artifact loader is present for each scope.

For example, artifact loader 500 may receive a request to locate an artifact from the application. Artifact loader 500 may distribute these requests in the appropriate form to locators 506, 508, and 510. If a result is returned, artifact loader 500 may return the result to the application. Additionally, artifact loader 500 also may pass this request on to artifact loader 502 for further search and to determine whether other artifacts matching the criteria are present. If no artifacts matching the criteria are present, artifact loader 500 passes the request on to artifact loader 502. In a similar fashion, artifact loader 502 may perform searches using locators 512, 514, and 516 and also send the request on to artifact loader 504.

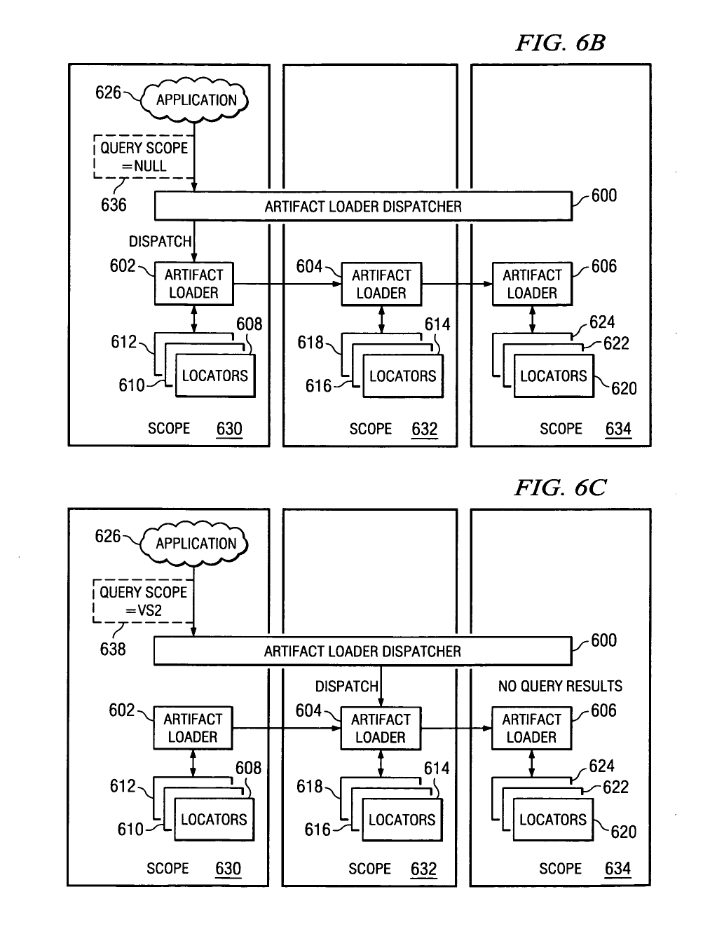

Turning now to FIGS. 6A-6C are diagrams illustrating an artifact loader framework in accordance with an illustrative embodiment of the present invention. In FIG. 6A, artifact loader dispatcher 600 dispatches requests to locate artifacts to artifact loaders 602, 604, and 606 depending on the particular scope. Artifact loader 602 is associated with locators 608, 610, and 612. Artifact loader 604 is associated with locators 614, 616, and 618, and artifact loader 606 is associated with locators 620, 622, and 624. In this example, application 626 sends query 628 to artifact loader dispatcher 600, rather than sending query 628 directly to one of the artifact loaders. Artifact loader dispatcher 600 does not gather results, but passes results gathered by the artifact loaders to the client.

In FIG. 6B, scope 630, 632, and 634 are present. In this particular example, application 626 is located within scope 630 along with artifact loader 602 and locators 608, 610 and 612. Scope 632 contains artifact loader 604 and locators 614, 616, and 618. Artifact loader 606 and locators 620, 622, and 624 are found in scope 634.

Artifact loader dispatcher 600 maintains responsibility for distributing queries received from application 626. These queries are distributed to the different artifact loaders in the different scopes. The scope that is used depends on what is defined within the query. Each query includes a scope parameter to define the scope in which the query should start. This scope parameter is valuable in a situation in which a prior artifact was returned from a particular scope. As a result, a client application, such as application 626, may desire to resolve a reference from that artifact and may begin with the resolution from the scope in which the original artifact was found. In this example, query 636 contains a null value for the scope.

In this particular example, a specific scope parameter is passed within query 636. Artifact loader dispatcher 600 examines the scope attribute and dispatches query 636 to the appropriate artifact loader managing scope. In dispatching query 636 to the appropriate artifact loader in these examples, artifact loader dispatcher 600 is not required to reformat this request. In other words, artifact loader dispatcher 600 serves to provide a routing function in these examples.

In this case, with a value of null for the scope parameter, artifact loader dispatcher 600 starts by sending this query to artifact loader 602. The particular artifact loader to which a query is sent when no scope is defined in the query may differ depending on the particular policy or rules set up for an artifact loader framework.

Generally, when a query is received by artifact loader dispatcher 600, this component parses the query to identify the scope. Artifact loader dispatcher 600 then dispatches the query to the artifact loader that manages the scope identified in the query. When a query is sent for a particular scope, the artifact loader managing that scope must federate or send the query to all location providers within the scope and then aggregate all of the results from all of the locators associated with the artifact loader.

If the aggregation of results from all the locators provides one or more positive results, the artifact loader in that scope returns the results of the query back to the artifact loader client. In these examples, a positive result is a result in which an artifact matching the criteria has been located. In this example, the client is the application requesting the artifact. If no artifacts are found within the scope being queried, the query is then delegated to the next artifact loader in the hierarchy. If no artifacts match the request sent to the locators, this result also is referred to as a negative result.

As can be seen in FIG. 6B, query 636 also does not identify scope in the scope parameter. As a result, the default scope is set as the scope in which application 626 is located. In this example, the scope is scope 630. Artifact loader dispatcher 600 dispatches query 636 to artifact loader 602. If no positive results are returned, query 636 is then passed on to artifact loader 604. In turn, if no positive results are found by locators 614, 616, and 618, query 636 is then passed on to artifact loader 606.

In FIG. 6C, query 638 is received from application 626. Artifact loader dispatcher 600 identifies a scope parameter of VS2, identifying scope 632 as the scope in which the query should be dispatched. As a result, artifact loader dispatcher 600 dispatches query 638 to artifact loader 604, which is assigned to scope 632. This type of dispatching occurs even though the client, application 626 is operating within scope 630.

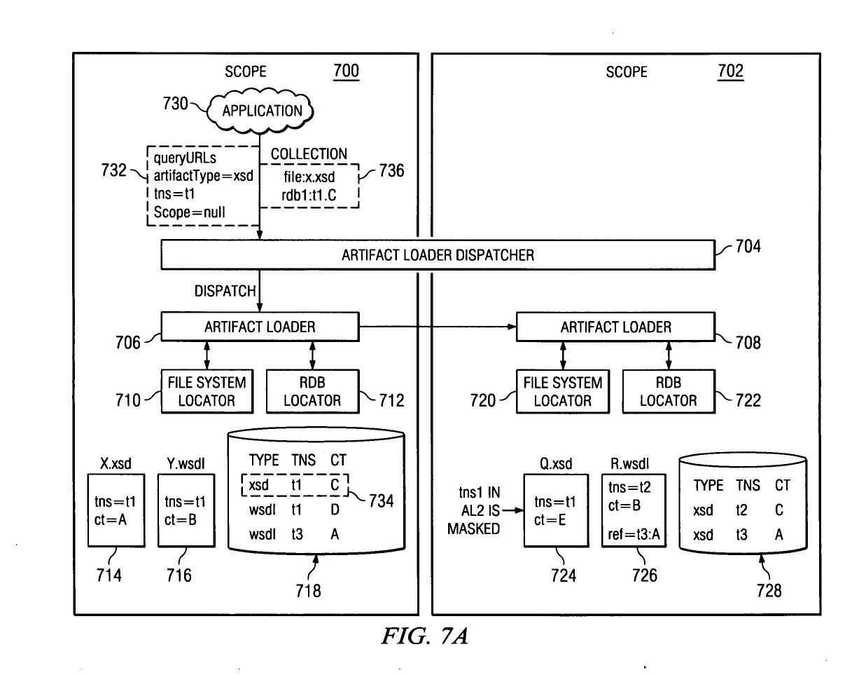

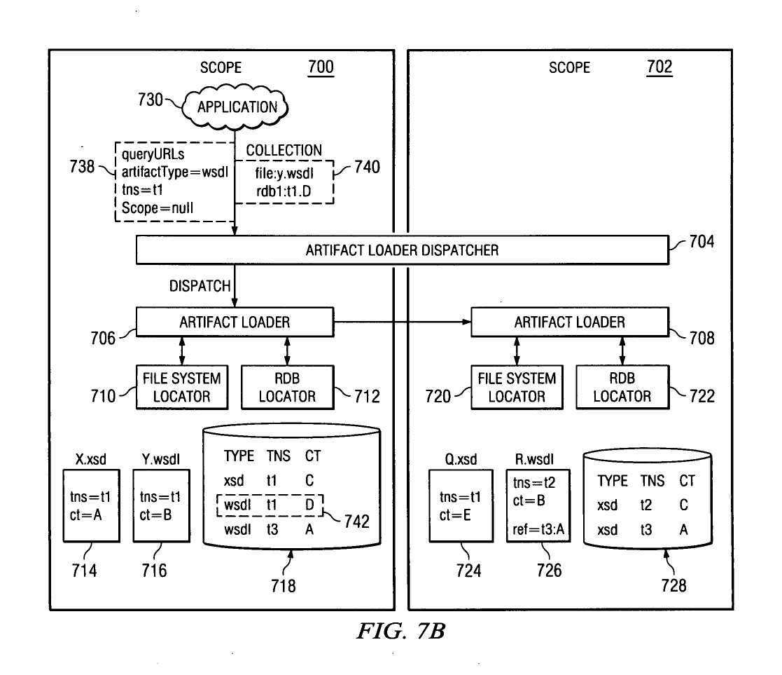

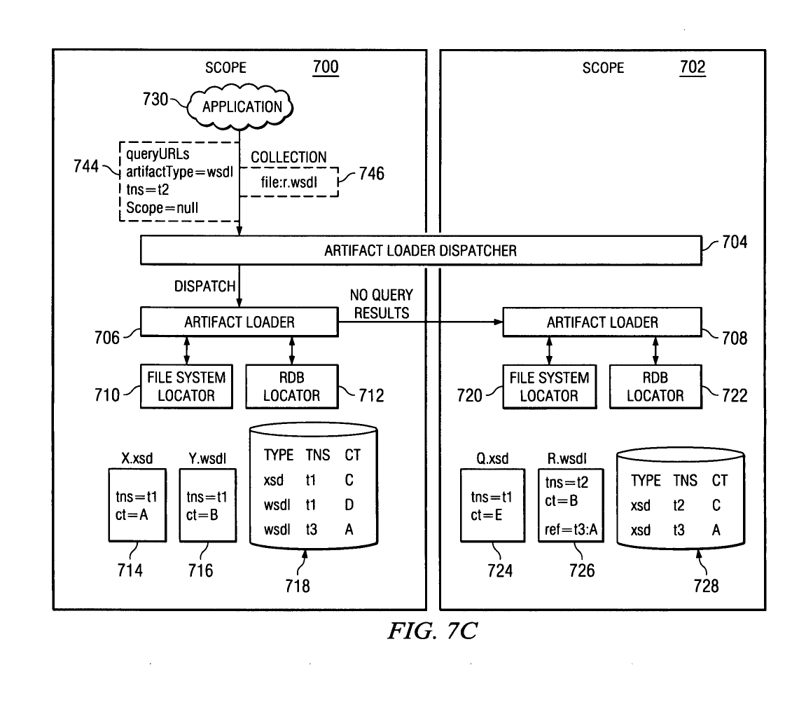

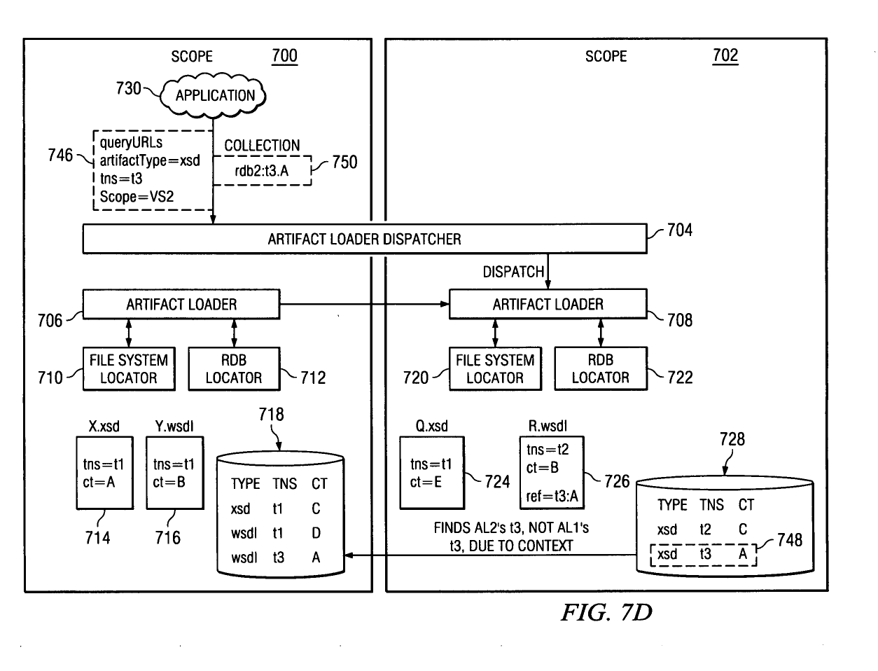

Artifact loader 604 uses locators 614, 616, and 618 to determine whether an artifact matching query 638 is present within scope 632. If no results are returned, artifact loader 604 federates or sends query 638 to artifact loader 606. In turn, artifact loader 606 uses locators 620, 622, and 624 to determine whether any artifacts are present within scope 634 that match the criteria in query 638. If no positive results are returned by these locators, an empty query is returned to application 626. With reference now to FIGS. 7A-7D, diagrams illustrating example implementations using a generic artifact loader framework are depicted in accordance with different aspects of the present invention. The different implementations illustrated in FIGS. 7A-7D are provided for purposes of describing exemplary environments in which an illustrative embodiment of the present invention may be implemented. These examples are not meant to be limitations to the different environments in which an embodiment of the present invention may be used.

In FIG. 7A, two scopes are present, scope 700 and scope 702. Artifact loader dispatcher 704 dispatches queries to artifact loaders 706 and 708. File system locator 710 and relational database (RDB) locator 712 are locators used to identify artifacts in scope 700.

In these examples, the artifacts handled are extensible markup language schema definition (XSD) and web services Description language (WSDL) definitions. XSD is an informal name for the XML schema in W3C, while WSDL is an XML based language for defining web services and describes protocols and formats used by service.

File system locator 710 may be used to search files in a file system. In these examples, these files include XSD file 714 and WSDL file 716. Relational database locator 712 is used to search a relational database, such as relational database 718. As previously mentioned, these locators may be implemented using currently available search processes or components that are found in file systems and databases. Alternatively, custom designed processes or components may be created to facilitate searching for artifacts.

In a similar fashion, artifact loader 708 is associated with file system locator 720 and relational database locator 722. File system locator 720 searches for files, such as XSD file 724 and WSDL file 726. Relational database locator 722 searches for data within relational database 728.

In this particular example, application 730 sends query 732 to artifact loader dispatcher 704. In this example, the scope is set equal to null. As a result, the query is sent by artifact loader dispatcher 704 into scope 700 as the default scope based on the scope in which application 730 is located. This particular query is for a particular XSD artifact type in which a target name space of t1 is defined.

Artifact loader 706 sends requests to both file system locator 710 and relational database locator 712. File system locator 710 identifies XSD file 714 as matching the parameter for the artifact. Additionally, relational database locator 712 identifies entry 734 as matching the parameter in the query. Pointers in the form of URLs to these two artifacts are returned in collection 736. In this case, query 732 is not passed on to artifact loader 708 and XSD file 724 is not identified or returned in the results in FIG. 7A. Depending on the particular implementation, query 732 may be passed on to artifact loader 708 even though identifications of artifacts matching parameters in the query are found by artifact loader 706, depending on the particular implementation.

In FIG. 7B, query 738 is generated by application 730 and sent to artifact loader dispatcher 704. In this particular example, query 738 defines the artifact type as a WSDL with name space t1. Again, the scope is set equal to null. Artifact loader dispatcher 704 sends query 738 to artifact loader 706. Artifact loader 706 generates and sends requests to file system locator 710 and relational database locator 712. File system locator 710 identifies WSDL file 716 as an artifact matching the parameters of query 738 by file system locator 710. Additionally, entry 742 is located by relational database locator 712 as matching the artifact type. These two results are returned in collection 740 to application 730.

In FIG. 7C, application 730 generates query 744. This query identifies the artifact type as being a WSDL file with name space t2. The scope is set equal to null. In response to receiving query 744, artifact loader dispatcher 704 sends query 744 to artifact loader 706 in scope 700. Scope 700 again is the default scope when no scope is identified in query 744. In this case, artifact loader 706 sends requests to file system locator 710 and relational database locator 712. No artifacts are identified in this example matching the parameters in query 744. As a result, artifact loader 706 passes query 744 on to artifact loader 708 and scope 702. In turn, artifact loader 708 sends requests to file system locator 720 and relational database locator 722. These requests result in an identification of WSDL file 726 as matching the parameter in query 744. The pointer to this file is returned to application 730 in collection 746.

In FIG. 7D, application 730 generates query 746 in which the artifact type is defined as an XSD file. The parameter target name space is t3, and in this case, the scope is defined as scope 702. Artifact loader dispatcher 704 dispatches this query to artifact loader 708 in scope 702. Artifact loader 708 sends requests to file system locator 720 and relational database locator 722. Entry 748 in relational database 728 is identified as the artifact matching query 746. As a result, a pointer to this artifact is returned in collection 750 to application 730. In this example, the pointer is a single URL representing a row or entry from relational database 728.

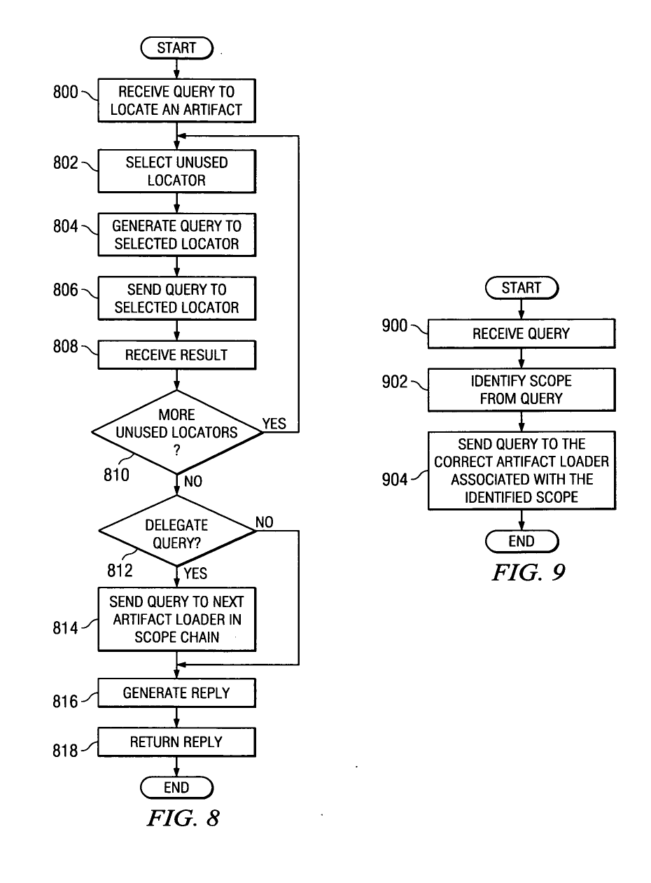

Turning now to FIG. 8, a flowchart of a process for processing a query in an artifact loader is depicted in accordance with a preferred embodiment of the present invention. The process illustrated in FIG. 8 may be implemented in an artifact loader, such as artifact loader 400 in FIG. 4. Of course, this process may be implemented in any of the artifact loaders illustrated in these examples.

The process begins by receiving a query to locate an artifact (step 800). Next, an unused locator is selected (step 802). A query is generated to selected locator (step 804). Thereafter, a query is sent to selected locator (806) with a result received (step 808). Next, a determination is made as to whether more unused locators are present (step 810). If more unused locators are present, the step returns to step 802. If more unused locators are not present, a determination is made as to whether the query is to be delegated (step 812). The decision in step 812 may be made based on whether a positive or negative result was returned from the locators. In these illustrative examples, the query is delegated if a negative result is returned. Alternatively, the implementation may always delegate the query or never delegate the query. If the query is to be delegated, the query is sent to the next artifact loader in the scope chain (step 814). This artifact loader is located in another scope. The selection of the artifact loader may be made in a number of different ways. The selection may be based on a policy or a default artifact loader may be used. Thereafter, a reply is generated (step 816). Finally, a reply is returned (step 818) with the process terminating thereafter.

With reference again to step 812, if the query is not to be delegated, the process proceeds to step 816 as described above.

In FIG. 9, a flowchart of a process for sending a query to an artifact loader is depicted in accordance with a preferred embodiment of the present invention. The process illustrated in FIG. 9 may be implemented in an artifact loader dispatcher, such as artifact loader dispatcher 600 in FIG. 6A-6C or artifact loader 704 in FIG. 7A-7D.

The process begins by receiving a query (step 900). Next, the scope is identified from a query (step 902). Thereafter, the query is sent to the correct artifact loader associated with the identified scope is sent (step 904) with the process terminating thereafter. The correct artifact loader may be identified using a data structure in which artifact loaders and associated scopes are found.

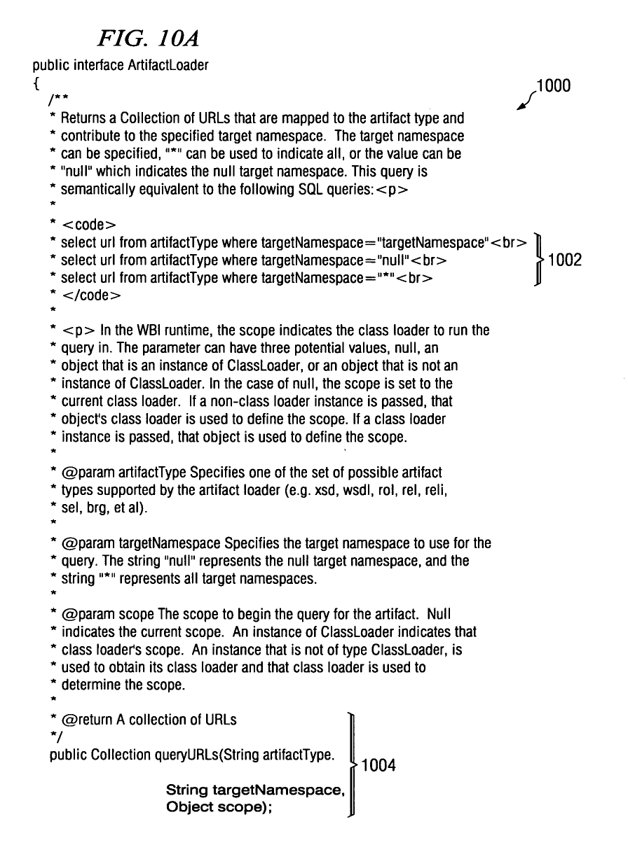

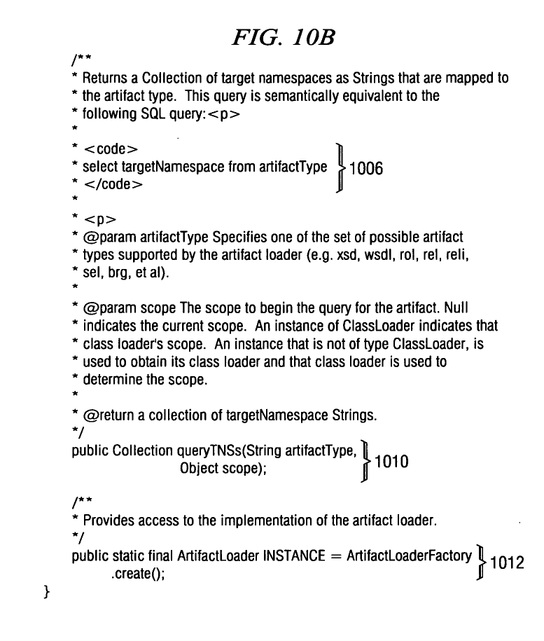

With reference to FIGS. 10A-10B, example computer usable code for an artifact loader is depicted in accordance with an illustrative embodiment of the present invention. In these examples, the code is illustrated using the Java language.

Code 1000 is an example of an artifact loader that calls a single-service provider or locator interface. Section 1002 contains code used to retain a collection of URLs that are mapped to artifact type and contribute to a specified name space. Section 1004 is used to return a collection of URLs that are mapped to the artifact type and contribute to the specified target name space. Section 1006 in code 1000 is used to return a collection of target name spaces as strings that are mapped to an artifact type. Section 1010 is used to return a collection of target names spaces as strings that are mapped to the artifact type. Section 1012 in code 1000 is used to provide access to the artifact loader.

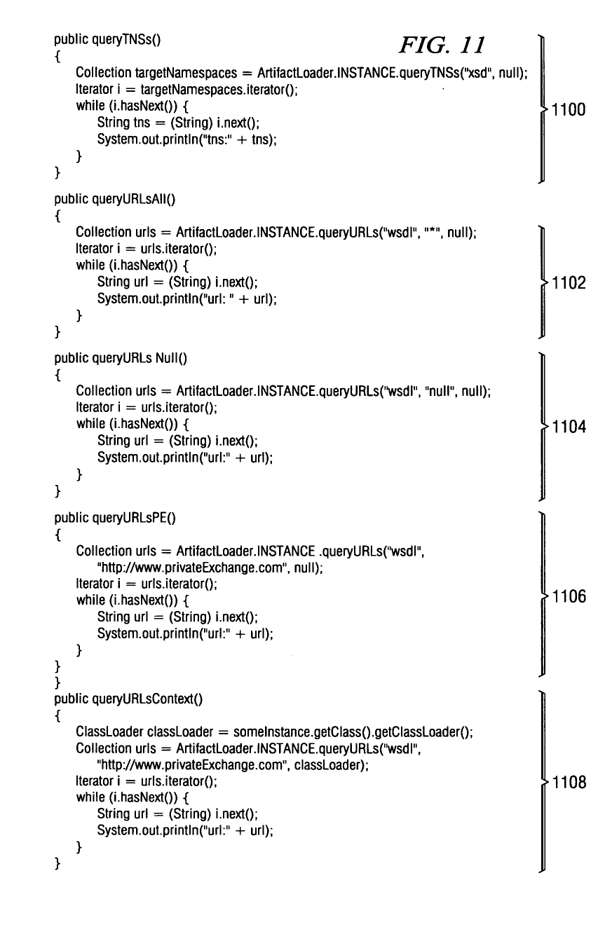

Turning now to FIG. 11, a diagram illustrating example code snippets used to call an artifact loader is depicted in accordance with an illustrative embodiment of the present invention. Code snippets 1100, 1102, 1104, 1106, and 1108 are examples of snippets that may be used to call an artifact loader such as the artifact loader illustrated in FIGS. 10A-10B.

The environment illustrated for the code in FIGS. 10A-10B and FIG. 11 is for an artifact loader called by a J2SE client that directly interfaces with the artifact loader. With respect to this example, a default environment is assumed if the artifact loader has not been bootstrapped by another environment. The J2SE environment provides a single artifact loader that manages the scope for the current client's class loader. No training is illustrated by this particular example. The single artifact loader in a J2SE environment leverages a single locator, which is a J2SE locator. This locator is also referred to as a J2SE file system locator. For this particular example, the system property “system.classpath” is the metadata that is used to determine the scope for the J2SE locator. Each directory in that class path is searched reclusively for artifact types. Each file in the class path that has the extension zip, .jar, .rar, or .ear is opened as a zip/jar file and searched reclusively for artifacts. The artifact types that may be supported in this example are those supported by the J2SE file system locator and occurs by mapping artifact types to extensions in the file system.

Thus, the present invention provides a method, apparatus, and computer usable code for searching for artifacts. The different aspects of the present invention allows for a generic searching mechanism to search for artifacts when receiving queries or requests from client applications. The illustrative framework allows for searches to occur within the scope in which the application is located as well as other scopes. In this manner, an application does not need to include coding to search for particular artifacts for each particular case.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for locating artifacts, the method comprising:
receiving a query from a client to locate an artifact, wherein the query includes a set of criteria for the artifact,
responsive to receiving the query, sending a request to a set of locators based on the set of criteria in the query; and
responsive to receiving a positive response from the set of locators, returning a reply to the client, wherein the reply includes a pointer to the artifact.

2. The method of claim 1, wherein the sending step comprises:
responsive to receiving the query, identifying a scope for the request to form an identified scope; and
after identifying the identified scope, sending the request to locators in the set of locators within the identified scope.

3. The method of claim 1, wherein the pointer points to a first location and wherein the reply further comprises a second pointer to the artifact in another location.

4. The method of claim 1, wherein the pointer is a universal resource locator.

5. The method of claim 1, wherein the receiving step, the sending step, and the returning step are performed by an artifact loader.

6. The method of claim 1, wherein the query is received from the client through an artifact loader dispatcher.

7. The method of claim 5, wherein the artifact loader is associated with a scope and further comprising:
responsive to receiving a negative response, sending the request to another artifact loader associated with another scope.

8. The method of claim 1, wherein the criteria in the query includes at least one of a type and name space.

9. An artifact loading system comprising:
an artifact loader; and
a set of locators, wherein the artifact loader receives a query from a client to locate an artifact in which the query includes a set of criteria for the artifact; a request is sent by the artifact loader to the set of locators based on the set of criteria in the request responsive to receiving the query; and a reply is returned to the client in which the reply includes a pointer to the artifact in response to the artifact loader receiving a positive response from the set of locators.

10. The artifact loading system of claim 9 further comprising:
a second artifact loader; and
a second set of locators, wherein the second artifact loader receives the query from the first artifact loader in response to a negative response being receiving the artifact loader; the second artifact loader sends a particular request to the second set of locators based on the set of criteria in the query in response to receiving the query; and second artifact loader returns the reply in response to the second artifact loader receiving the positive response from the second set of locators.

11. The artifact loading system of claim 9 further comprising:
an artifact loader dispatcher, wherein the artifact loader dispatcher initially receives the query from the client and dispatches the query to the artifact loader in response to identifying the artifact loader as being associated with an identified scope for the query.

12. The artifact loading system of claim 9, wherein the pointer points to a first location and wherein the reply further comprises a second pointer to the artifact in another location.

13. The artifact loading system of claim 9, wherein the pointer is a universal resource locator.

14. The artifact loading system of claim 9, wherein the request is received from the client through an artifact loader dispatcher.

15. The artifact loading system of claim 9, wherein the criteria in the query includes at least one of a type and name space.

16. A computer program product for locating artifacts, the computer program product comprising:
a computer usable medium having computer usable program code for locating artifacts in a data center, said computer program product including:
computer usable program code for receiving a query from a client to locate an artifact, wherein the query includes a set of criteria for the artifact;
computer usable program code for sending a request to a set of locators based on the set of criteria in the query in response to receiving the request; and
computer usable program code for returning a reply to the client, wherein the reply includes a pointer to the artifact in response to receiving a positive response from the set of locators.

17. The computer program product of claim 16, wherein the computer usable program code for sending a query to a set of locators based on the set of criteria in the request in response to receiving the request further comprises:
computer usable program code for identifying a scope for the request to form an identified scope in response to receiving the request; and
computer usable program code for sending the query to locators in the set of locators within the identified scope after identifying the identified scope.

18. The computer program product of claim 16, wherein the pointer points to a first location and wherein the reply further comprises a second pointer to the artifact in another location.

19. The computer program product of claim 16, wherein the pointer is a universal resource locator.

20. The computer program product of claim 16, wherein the computer usable program code is for an artifact loader.

21. The computer program product of claim 16, wherein the request is received from the client through an artifact loader dispatcher.

22. The computer program product of claim 20, wherein the artifact loader is associated with a scope and further comprising:
computer usable program code for sending the request to another artifact loader associated with another scope in response to receiving a negative response,.

23. The computer program product of claim 16, wherein the criteria in the request includes at least one of a type and name space.
